(19) United States
(12) Patent Application Publication
(10) Pub. No.: US 2008/0239406 A1
(43) Pub. Date: Oct. 2, 2008

(54) COMMUNICATION DEVICE

(75) Inventor: Keiichi Nakano, Komaki-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 12/056,007

(22) Filed: Mar. 26, 2008

(30) Foreign Application Priority Data
Mar. 27, 2007 (JP) 2007082951

(51) Int. Cl. H04N 1/00

(52) U.S. Cl. 358/401

(57) ABSTRACT

A communication device has a reading unit, a wireless tag reading unit, a transmitting unit, a designating unit, a first determining unit, and a control unit. The a reading unit reads image data from an original document. The original document has a first wireless tag including first wireless tag data. The first wireless tag data includes first copying number data having first number of time for allowing copying the original document. The first number is more than or equal to zero. The wireless tag reading unit reads the first wireless tag data from the wireless tag. The transmitting unit transmits the image data. The designating unit designates second number of second communication device to which the image data is transmitted. The second number is more than zero. The first determining unit determines whether the first number is more than the second number. The control unit determines based on a determination by the first determining unit whether the transmitting unit is allowed to transmit the image data or not.

### CROSS REFERENCE TO RELATED APPLICATIONS

This application claims priority from Japanese Patent Application No. 2007-082951 filed Mar. 27, 2007. The entire content of the priority application is incorporated herein by reference.

### TECHNICAL FIELD

The present invention relates to a communication device capable of transmitting and receiving image data and wireless tag data recorded in an original document in a manner associating these data with each other. In particular, the present invention relates to a communication device that limits the number of times for copying the document which is a subject of transmission and reception.

### BACKGROUND

A technique for limiting the number of times for copying a document by using a wireless tag added to the document has been suggested. For example, Japanese Patent Publication No. 2006-094037 discloses a copying device that reads data indicating the number of times of allowable copying from the wireless tag of a document, and determines based on the number of times of allowable copying whether the copying document is permitted or not.

The copying device described above completes all processing in one copying device for the copying. Therefore, a function and a state of the device itself (for example, reading of a wireless tag, presence or absence of a writing function, and presence or absence of recording paper to which a wireless tag is added) can be easily grasped. Accordingly, the copying device can easily limit the number of times for copying the document only by reading the number of times of allowable copying from the wireless tag and making determination based on the number of times of allowable copying.

However, if the device is a communication device, at least two devices; one for transmission and other for reception are required for communication. That is, in order to limit the number of copying the document for transmission and reception, a function for the wireless tag in a designated facsimile device (for example, presence or absence of a function for reading a wireless tag, and presence or absence of recording paper having a wireless tag) need to be grasped. With respect to this point, the technique described in JP Publication No. 2006-094037 is not available as the communication device since the processing disclosed in JP Publication No. 2006-094037 assumes to be completed in one copying device.

### SUMMARY

The present invention has been made in order to resolve the conventional problem described above, and relates to a communication device capable of transmitting and receiving image data and wireless tag data in a manner associating such data with each other. In particular, an object of the present invention is to provide a communication device capable of appropriately limiting the number of times for copying of a document as a subject of transmission and reception on a transmission side or a reception side.

The present invention provides a communication device having a reading unit, a wireless tag reading unit, a transmitting unit, a designating unit, a first determining unit, and a control unit. The a reading unit reads image data from an original document. The original document has a first wireless tag including first wireless tag data. The first wireless tag data includes first copying number data having first number of time for allowing copying the original document. The first number is more than or equal to zero. The wireless tag reading unit reads the first wireless tag data from the wireless tag. The transmitting unit transmits the image data. The designating unit designates second number of second communication device to which the image data is transmitted. The second number is more than zero. The first determining unit determines whether the first number is more than the second number. The control unit determines based on a determination by the first determining unit whether the transmitting unit is allowed to transmit the image data or not.

The present invention provides a communication device, having a receiving unit, a separating unit, a printing unit, a writing unit, a storing unit, a first determining unit, and a control unit. The receiving unit receives data including image data and wireless tag transmission data through lines. The separating unit separates the wireless tag transmission data from the image data. The printing unit prints the image data on a recording sheet. The writing unit writes the wireless tag transmission data to a wireless tag. The storing unit stores the received data. The first determining unit determines whether the recording sheet has the wireless tag or not. The control unit controls the printing unit, the writing unit, and the storing unit. The printing unit prints the image data on the recording sheet and the writing unit writes the wireless tag transmission data in the wireless tag, if the first determining unit determines that the recording paper has the wireless tag. The storing unit stores the received data, if the first determining unit determines that the recording paper does not have the wireless tag.

### BRIEF EXPLANATION OF THE DRAWINGS

The particular features and advantages of the invention as well as other objects will become apparent from the following description taken in connection with the accompanying drawings, in which:

FIG. 1 is a schematic sectional view of a facsimile device of an embodiment according to the present invention;

FIG. 2 is a block diagram showing a control system of the facsimile device;

FIG. 3A is a schematic view illustrating communication between two facsimile devices;

FIG. 3B is a diagram showing one-page facsimile data including wireless tag data and image data;

FIG. 4A is a circuit diagram showing a wireless tag;

FIG. 4B is a block diagram illustrating a wireless tag reader and a wireless tag writer;

FIG. 5 is a block diagram showing contents of wireless tag data;

FIG. 6 is a flowchart showing a former part of a facsimile-transmission procedure;

FIG. 7 is a flowchart showing a latter part of the procedure shown in FIG. 6; and

FIG. 8 is a flowchart showing a facsimile reception procedure.

### DETAILED DESCRIPTION

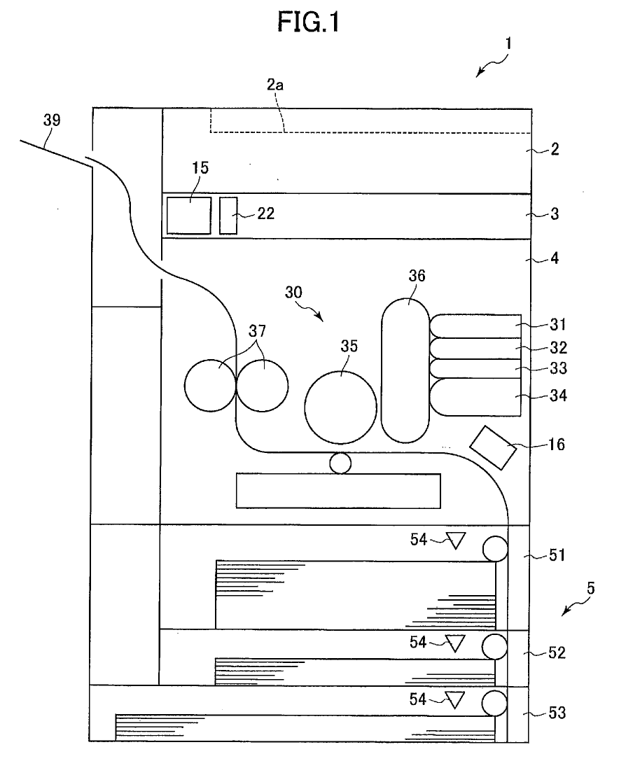

An embodiment of the present invention will be described, with reference to the accompanying drawings. Referring to FIG. 1, a facsimile device 1 has an automatic document feeder 2, a scanner unit 3, a printer unit 4, and a sheet-feeding tray unit 5.

The automatic document feeder 2 has a document table unit 2a. An original document to be sent by facsimile is placed on the document table unit 2a with the surface thereof facing downward. When a user pushes a start key (not shown) provided on the facsimile device 1, the original document is fed on a page basis to the scanner unit 3, which reads image data from the document. After the scanner unit 3 has read data from each page, the original document is ejected through a document-ejecting port (not shown).

The scanner unit 3 has a wireless tag reader 15 and a scanner 22. When the document having a wireless tag is fed, the wireless tag reader 15 reads wireless tag data recorded in the wireless tag by wireless. The scanner 22 reads image data from the original document on a page basis regardless of whether the original document has the wireless tag. In this embodiment, the wireless tag is a recording medium on which data is written and read without physically contacting therewith and called as an IC tag or a radio frequency identification tag (RFID). The “wireless tag attached to an original document” means not only a wireless tag affixed to the document, but also, for example, a wireless tag embedded in the document.

The printer unit 4 has a wireless tag writer 16 and a laser printer 30. The wireless tag writer 16 is configured to write data in a wireless tag attached to a recording sheet fed from the sheet-feeding tray unit 5. The laser printer 30 has a yellow (Y) station 31, a magenta (M) station 32, a cyan (C) station 33, and a black (K) station 34. The Y station 31 contains yellow toner, the M station 32 contains magenta toner, the C station 33 contains cyan toner, and the K station 34 contains black toner. The laser printer 30 further has a transfer drum 35, an intermediate-transfer belt 36, and fixing rollers 37. The intermediate-transfer belt 36 transfers toner from the stations 31, 32, 33 and 34 to the transfer drum 35. The recording sheet to which the image is formed by the laser printer 30 is ejected onto an ejected sheet stacker 39.

The sheet-feeding tray unit 5 has three sheet-feeding trays 51, 52 and 53. Each of the sheet-feeding trays 51, 52 and 53 has a sensor 54. The sensor 54 detects whether the wireless tag is attached to the recording sheet accommodated in the sheet-feeding trays 51, 52 and 53. If the wireless tag is attached to the sheet, the sensor 54 detects a vacant writing capacity of the wireless tag for storing data. In other words, the sensor 54 can detect the possible capacity of the wireless tag attached to or embedded in each sheet stacked in the sheet-feeding trays 51, 52 and 53.

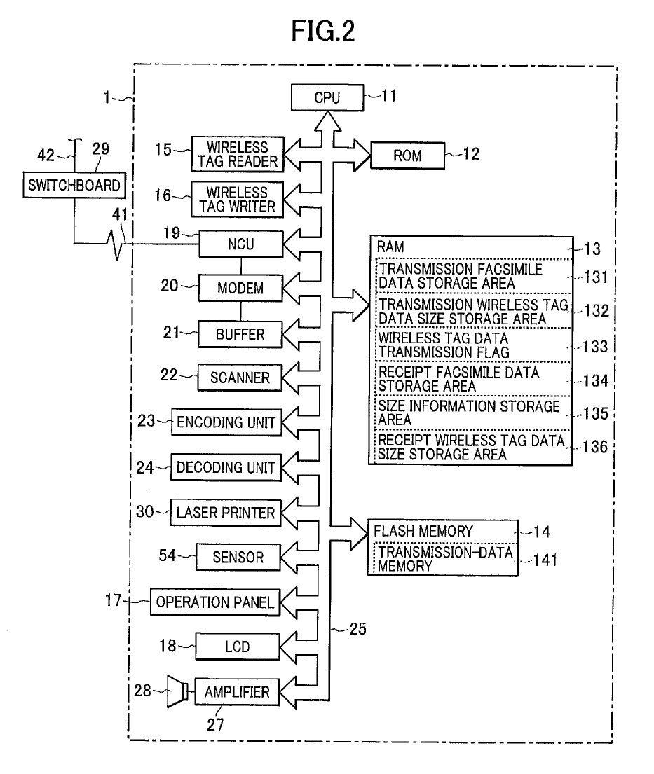

Referring to FIG. 2, the facsimile device 1 has a CPU 11, a ROM 12, a RAM 13, and a flash memory 14. These components are connected to one another together with peripheral devices such as a network control unit 19 (hereinafter referred to as “NCU”) through a bus line 25.

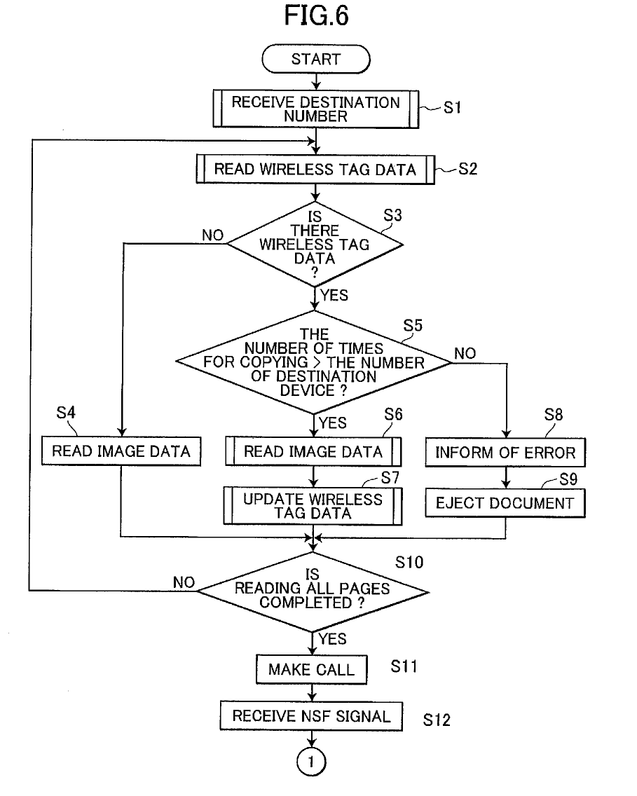

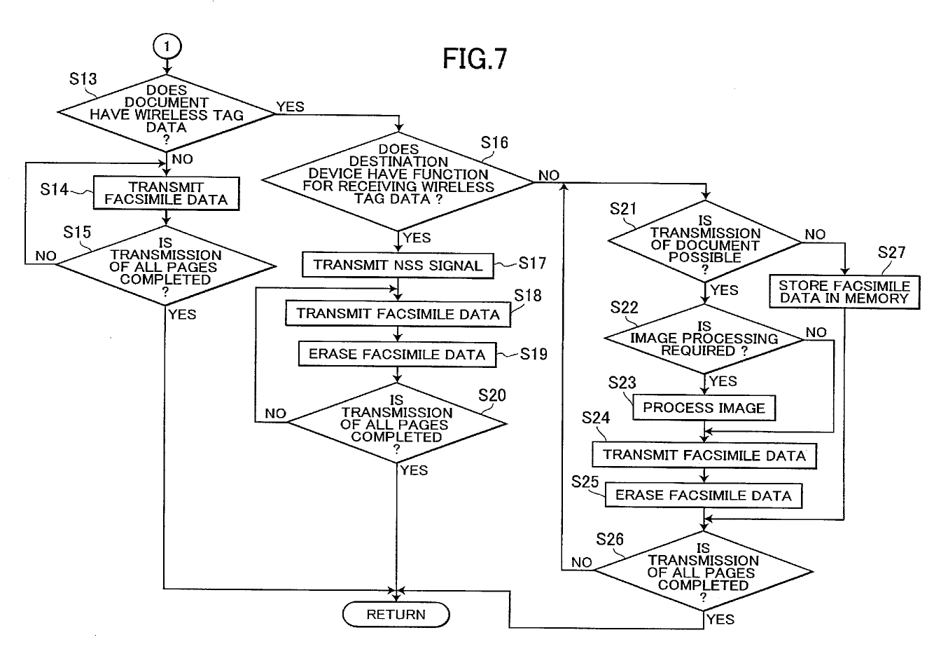

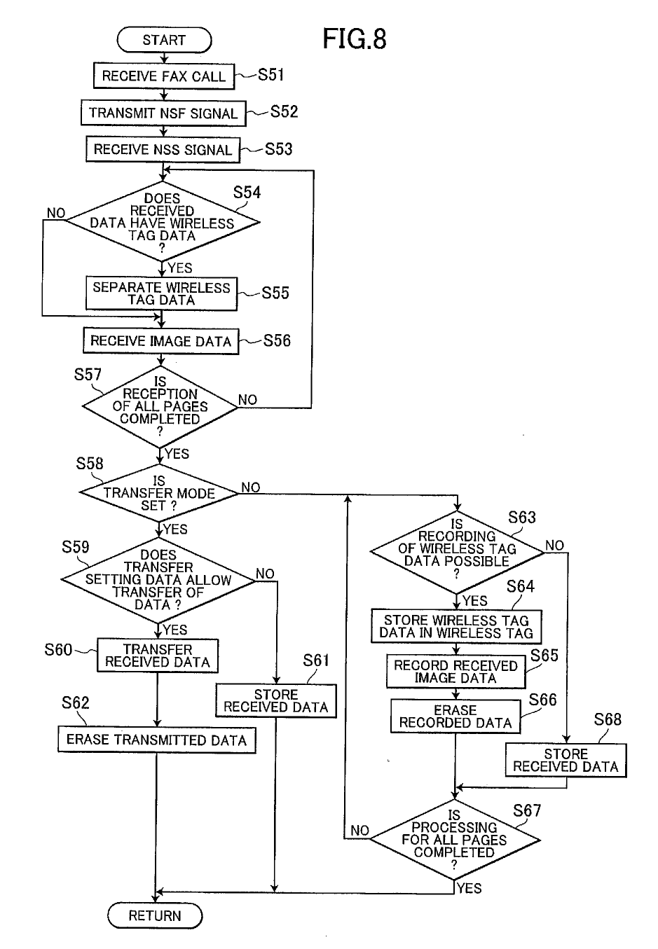

The CPU 11 receives various signals from the NCU 19 which performs line control, control each unit connected through the bus line 25, and performs facsimile operation. That is, the CPU 11 performs data communication. The ROM 12 is not rewritable for storing control programs that are executed by the CPU 11. More specifically, The ROM 12 stores a variety of control programs, such as a fax transmission processing program (see FIGS. 6 and 7), and a fax reception processing program (see FIG. 8) described later.

The RAM 13 is a memory that temporarily stores various data while the facsimile device 1 is operating. The RAM 13 has a transmission facsimile data storage area 131, a transmission wireless tag data size storage area 132, a wireless tag data transmission flag 133, a receipt facsimile data storage area 134, a size information storage area 135, and a receipt wireless tag data size storage area 136.

The transmission facsimile data storage area 131 is a storage area for storing the facsimile data 63 configured by the image data and the wireless tag data. The detailed explanation of the image data and the wireless tag data will be described later.

The transmission wireless tag data size storage area 132 is a storage area for storing, for each page, data size, data volume, of the wireless tag data read by the wireless tag reader 15.

The wireless tag data transmission flag 133 is a flag that indicates whether a designated communication device 60 which intends to receive data from the facsimile device 1 has the function of writing the wireless tag data. The facsimile device 1 determines the method to transmit the facsimile data including the image data, depending on the contents of the wireless tag data transmission flag 133. The operation of the facsimile device 1 will be explained later in detail.

The reception facsimile data storage area 134 is a storage area for storing the received facsimile data 63. The facsimile data 63 is erased from the reception facsimile data storage area 134 after the image based on the image data has been formed on the recording sheet 71 and the wireless tag data has been written in the wireless tag 72 attached to the recording sheet 71. If the recording sheet 71 attached with a wireless tag 72 is not available, the facsimile data 63 is not erased, remaining saved in the received facsimile data storage area 134.

The size information storage area 135 is a storage area for storing the size information transmitted from another communication device. The size information includes data indicating whether the wireless tag data is included in the facsimile data 63, and another data indicating a data size, data volume of the wireless tag data included in the facsimile data 63.

The reception wireless tag data size storage area 136 is a storage area for storing the data size of the wireless tag data for each page, contained in the facsimile data 63 received from the another communication device.

The flash memory 14 is a writable nonvolatile memory, and includes a transmission-data memory 141 for storing transmission data. As will be described later, the image data ready by the scanner 22 is stored in the transmission-data memory 141 if the transmission of the facsimile data to the communication device 60 is inhibited.

Referring to FIG. 2, the facsimile device 1 has a wireless tag reader 15, a wireless tag writer 16, the NCU 19, a modem 20, a buffer 21, the scanner 22, an encoding unit 23, a decoding unit 24, the laser printer 30, the sensor 54, an operation panel 17, a liquid crystal display (LCD) 18, and an amplifier 27. These components are connected to one another through the bus line 25.

The wireless tag reader 15 is designed to read wireless tag data from the wireless tag. The wireless tag writer 16 is configured to write wireless tag data into a wireless tag.

The modem 20 is configured to modulate, demodulate, and transmit the facsimile data 63 and to transmit and receive various sequence signals for use in transmission control. The buffer 21 is provided in the communication device for temporarily storing data that contains coded facsimile data which is received from and to be transmitted to the facsimile device.

The encoding unit 23 is configured to encode facsimile data 63 for transmission thereof. The decoding unit 24 is designed to read the received data from the buffer 21 and decode the same.

The laser printer 30 is a device that prints the image data decoded at the decoding unit 24 on the recording sheet stacked in one of the first sheet-feeding tray 51 to the third sheet-feeding tray 53.

The detection sensor 54 is arranged in each of the first sheet-feeding tray 51 to the third sheet-feeding tray 53, and detects whether the wireless tag is attached to the recording sheet contained in each of the sheet-feeding trays.

The operation panel 17 is configured with a plurality of keys including a plurality of numerical keys and the start key described above. When any one of the keys configuring the operation panel 17 is operated, a corresponding input signal is sent to the CPU 11, and control based on the input signal is carried out. For example, in the facsimile device 1, the communication device 60 which receives facsimile data is designated by operating the keys.

The LCD 18 displays a variety of screens related to the facsimile device 1 based on control by the CPU 11. For example, when the communication device 60 is designated by using the operation panel 17, the LCD 18 displays a facsimile number of communication device 60 to which the facsimile data is to be transmitted. In addition, when an error in the number of times for copying is generated, the LCD 18 displays informing of the error in the number of times for copying (S8).

The amplifier 27 is connected to a speaker 28. The speaker 28 can generate a calling tone.

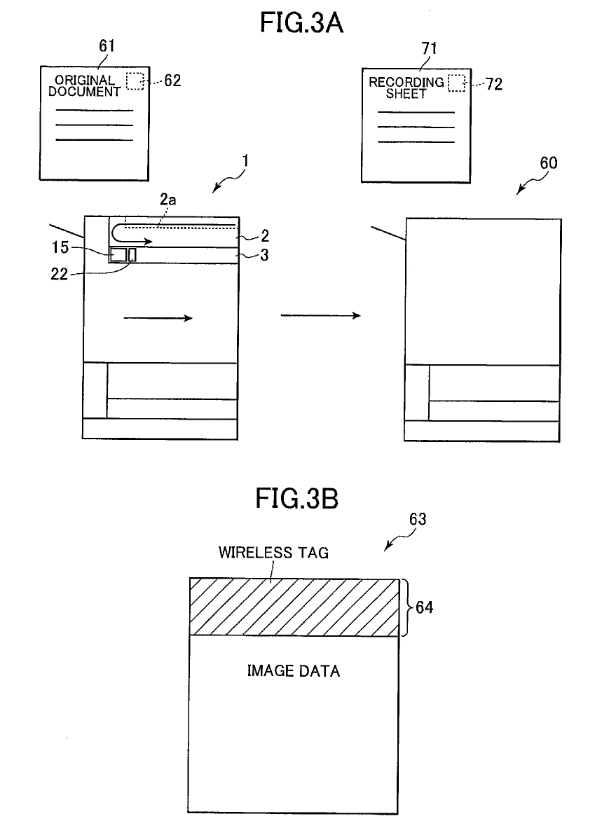

Further, the facsimile device 1 is connected to a exchanger 29 through the NCU 19 and a telephone line 41. The exchanger 29 is connected to an exchanger of the designated communication device 60 through a telephone line 42, and then to the communication device 60 through another telephone line. Therefore, the facsimile device 1 is able to transmit and receive the facsimile data 63 with the communication device 60 (see FIG. 3) through the telephone line 41, the exchanger 29, and the telephone line 42.

Next, the transmission and reception of the facsimile data 63 by the facsimile device 1 will be described in detail with reference to FIG. 3A. The communication device 60 shown in FIG. 3A has a configuration identical to the facsimile device 1.

As shown in FIG. 3A, an image (including figures and characters) has been formed on an original document 61 to be transmitted from the facsimile device 1. Further, a wireless tag 62 has been embedded in the original document 61. The original document 61 to be sent to the communication device 60 is set on the document table unit 2a. When the user touches the start key, the original document 61 is fed, page by page, to the reading position (not shown) in the scanner unit 3.

The reading position at which the wireless tag reader 15 reads the data from the wireless tag is located on the path along which the original document 61 is moved relative to the scanner 22. Hence, the wireless tag reader 15 reads the wireless tag data from the wireless tag 62 attached to the original document 61 while the automatic document feeder 2 is feeding the original document 61 to the reading position for the scanner 22. Thus, in order to read the image data and the wireless tag data from the original document 61, the user is simply required to place the original document 61 on the document table unit 2a. In view of this, the facsimile device 1 is user-friendly. In this embodiment, the data the wireless tag reader 15 reads from the wireless tag 62 is called wireless tag data. The positional relation of the scanner 22 and wireless tag reader 15 is not limited to the one shown in FIG. 1, but can be modified in various manners. For example, the wireless tag reader may be positioned outside the path in which the original document 61 is moved. In this case, only wireless tag data in the wireless tag can be first read as a whole rather the image data, if necessary.

As shown in FIG. 3B, the facsimile data 63 is composed of wireless tag data and image data which are associated with each other in the same page. When the facsimile data 63 is transmitted to the communication device 60 having the same configuration as that of the facsimile device 1, the device 60 prints an image on a recording sheet 71 (see FIG. 3A), using the image data contained in the facsimile data 63. Further, the communication device 60 writes the wireless tag data contained in the facsimile data 63 into the wireless tag 72 attached to the recording sheet 71. Thus, the image on the original document 61 and the wireless tag data in the wireless tag 62 attached to the original document 61 are transmitted from the facsimile device 1 to the communication device 60 and reproduced on the recording sheet 71 at the communication device 60 on a page basis. In this case the wireless tag 62 is written into the wireless tag 72 embedded in the recording sheet 71.

As shown in FIG. 3B, in the one-page facsimile data 63, the wireless tag data precedes the image data. Thus, only the image data is preventing from transmitting when any trouble occurs and the transmission of the facsimile data 63 from the facsimile device 1 to the communication device 60 is inevitably interrupted. The wireless tag data for each page can be reliably transmitted by facsimile. If the communication device 60 receives only the image data without receiving the wireless tag data that contains important information showing, for example, how to manage the image data, the image data might be managed in an improper manner in the communication device 60. This is why the wireless tag data should be transmitted prior to the image data.

Before transmitting the image data 63 from the facsimile device 1 to the communication device 60, the facsimile device 1 notifies the device 60 of the size information representing the data size, data volume, of the wireless tag data 64. In this manner, the communication device 60 identifies a predetermined size of data from a beginning of received data as the wireless tag data on the basis of the size information. In other words, the communication device 60 ensures to separate the image data and the wireless tag data in accordance with the size information to specify the wireless tag data of each page.

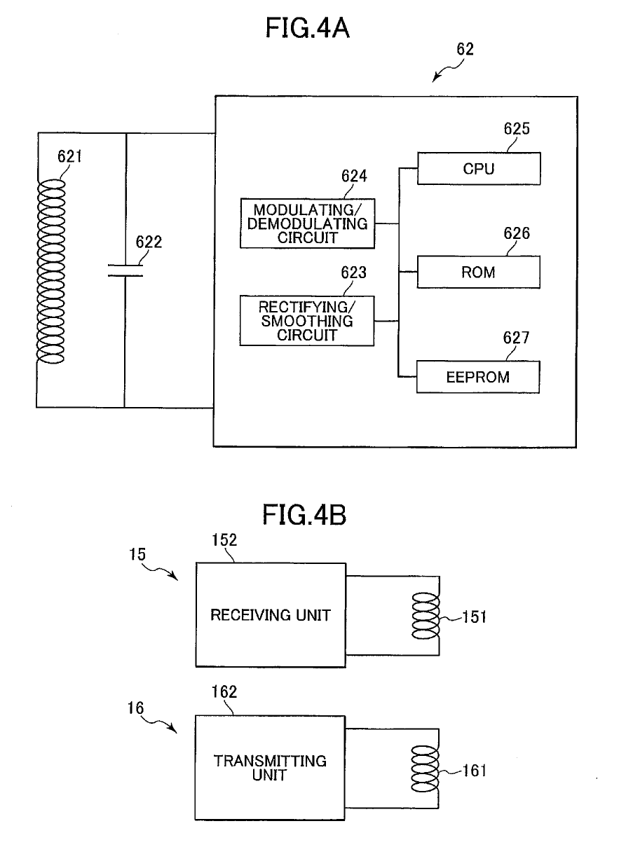

The wireless tag 62, wireless tag reader 15 and wireless tag writer 16 will be described with reference to FIGS. 4A and 4B. Note that, the wireless tag 72 attached to the recoding sheet 71 described with reference to FIG. 3A has the same configuration as the wireless tag 62. As shown in FIG. 4A, the wireless tag 62 has an antenna coil 621, a resonance capacitor 622, a rectifying/smoothing circuit 623, a modulating/demodulating circuit 624, a CPU 625, a ROM 626, and an EEPROM 627.

The antenna coil 621 is connected in parallel to the resonance capacitor 622 to form a resonance circuit. The resonance circuit receives a power radio signal transmitted from the wireless tag reader 15 or wireless tag writer 16 and having a prescribed high frequency. The received power radio signal is supplied to the rectifying/smoothing circuit 623.

The rectifying/smoothing circuit 623, which constitutes a power-supply circuit, receives the power radio signal from the resonance circuit. The rectifying/smoothing circuit 623 rectifies and smoothes the power radio signal and generates DC power of a specific voltage, which is supplied to the CPU 625.

The signal transmitted from the wireless tag reader 15 or wireless tag writer 16 is superposed on the power radio signal, demodulated by the modulating/demodulating circuit 624, and supplied to the CPU 625.

The CPU 625 operates in accordance with the operating program stored in the ROM 626 and performs a predetermined process in accordance with the signal supplied from the modulating/demodulating circuit 624. Thus, the CPU 625 writes the received data into the EEPROM 627 or read data from the EEPROM 627. The data read from the EEPROM 627 is modulated by the modulating/demodulating circuit 624 and transmitted as a radio signal from the antenna coil 621.

In the wireless tag 62, the rectifying/smoothing circuit 623, the modulating/demodulating circuit 624, the CPU 625, the ROM 626 and the EEPROM 627 are integrated into an IC chip. The IC chip is embedded in a recording sheet, together with the antenna coil 621 and the resonance capacitor 622.

As shown in FIG. 4B, the wireless tag reader 15 has a receiving unit 152 that has a receiving-antenna coil 151, and wireless tag writer 16 has a transmitting unit 162 that has a transmitting-antenna coil 161.

In the wireless tag reader 15, the receiving-antenna coil 151 receives a radio signal transmitted from the wireless tag 62. The receiving unit 152 demodulates the radio signal and discriminates the signal as wireless tag data. Thus, the wireless tag reader 15 reads the wireless tag data from the wireless tag 62.

In the wireless tag writer 16, the transmitting unit 162 modulates a carrier signal, and the transmitting-antenna coil 161 transmits the modulated carrier signal as a power radio signal. Thereafter, the transmitting unit 162 modulates the wireless tag data to be transmitted, and superposes the same on the power radio signal. The transmitting-antenna coil 161 transmits the wireless tag data thus superposed. Thus, the wireless tag writer 16 can write the wireless tag data into the wireless tag 62.

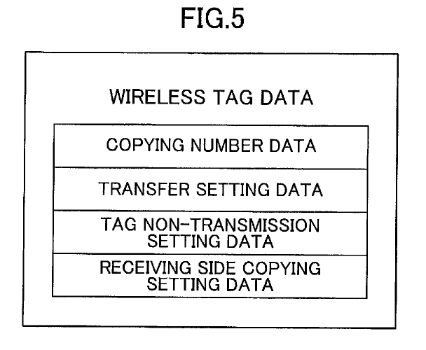

Next, a variety of types of data included in the wireless tag data will be described in detail with reference to FIG. 5. As shown in FIG. 5, the wireless tag data includes copying number data, transfer setting data, tag non-transmission setting data, and receiving side copy setting data.

The copying number data specifies the number of times for copying the image data in the document 61 (designated as the number of copying hereinafter). In this embodiment, one facsimile transmission to another communication device is counted as the number of copying. Even facsimile transmission is considered as a kind of normal copying from the point that the image data is reproduced.

As described later, when the number of copying indicated by the copying number data becomes “0” or lower, the facsimile transmission or the copying document 61 cannot be carried out any more.

The transfer setting data indicates whether transfer of data related to the document 61 is permitted or not. If the transfer setting data is “permission setting” that permits transfer data, the facsimile device 1 transfers the data to a predetermined destination device in a fax reception processing program described later. On the other hand, if the transfer setting data is “prohibition setting”, the facsimile device 1 does not transfer the data to the predetermined destination device in the fax reception processing program. Instead of the transmission, the device 1 stores the data in the flash memory 14.

Then, the tag non-transmission setting data specifies the method to transmit the data related to the document 61 when the destination communication device 60 does not have “a function for receiving the wireless tag data and writing in the wireless tag (hereinafter referred to as the wireless tag data receiving function)”.

The tag non-transmission setting data includes three settings: “transmission prohibition setting”, “transmission execution setting”, and “processing transmission setting”.

“Transmission prohibition setting” is a setting that transmitting processing of data is stopped. In accordance with “transmission execution setting,” only the image data of the document 61 is transmitted.

“processing transmission setting” is a setting in which image processing is applied to the image data of the document 61 and the processed image data is transmitted to the communication device. The image processing includes a process for reducing image quality, or a process for changing a color image to a monochrome image.

The receiving side copy setting data specifies the number of copying the recording paper 71, after the data related to the document 61 is transmitted to the facsimile device 60. The specified data by the receiving side copy setting data is written in the wireless tag 72.

The receiving side copy setting data includes “zero time setting”, “one time setting”, and “complete reproducing setting”.

“Zero time setting” is a setting in which the number of copying the recording paper 71 is set to be “zero” in the facsimile device 60. In this case, the copying number data indicating “the number of copying: 0” is written in the wireless tag 72 of the recording paper 71. That is, the recording paper 71 cannot be copied, nor transmitted to another communication device by facsimile.

“One time setting” is a setting in which the number of copying the recording paper 71 is set to be “once” in the communication device 60. In this case, the copying number data indicating “the number of copying: once” is written in the wireless tag 72 of the recording paper 71. That is, the recording paper 71 is available for only one copying, or only one facsimile transmission to other device.

“Complete reproducing setting” is a setting in which the number of copying the recording paper 71 is set to be “the same number of copying the document 61”. In this case, the number of copying in the wireless tag 62 is changed to “0”.

The copying number data, the transfer setting data, the tag non-transmission setting data, and the receiving side copy setting data are set in a suitable format, and written in the wireless tag 62 as the wireless tag data. Writing in the wireless tag 62 can be carried out when the user creates the document 61. Alternatively, writing in the wireless tag 62 can be executed before a first facsimile transmission in the facsimile device 1.

The types of the receiving side copy setting data are not limited to three settings described above, and may include other settings. Further, the relationship between the receiving side copy setting data and a content of updated the wireless tag 62 of the document 61 may be modified in different manners.

Next, the fax transmission processing program by the facsimile device 1 will be described in detail with reference to FIGS. 6 and 7.

When the fax transmission processing program is started with placing the document 61 on the document placing table 2A, the CPU 11 first executes a designation device input processing (S1). In the designation device input processing (S1), the CPU 11 receives a facsimile number of a designation device through the operation panel 17. At this time, the CPU 11 may receive a plurality of facsimile numbers of the devices 60 (generally called multicasting transmission). Then, the CPU 11 finishes the designation device input processing (S1) in response to the start key in the operation panel 17, and the process goes to step S2.

The auto sheet feeder 2 then feeds the document 61 placed on the document placing table 2A to the reading position of the scanner unit 3. At this time, while the document 61 is fed to the reading position, the CPU 11 executes a wireless tag data reading processing (S2). In the processing, the wireless tag reader 15 reads the wireless tag 62 attached to the document 61.

In step S3, the CPU 11 determines whether the wireless tag 62 stores the wireless tag data or not. If the wireless tag data is stored in the wireless tag (S3: YES), the CPU 11 then goes to step S5. On the other hand, if the wireless tag data is not stored (S3: NO), the CPU 11 goes to step S4. It should be noted that the fact that “the wireless tag data is not stored” includes the fact that “the wireless tag 62 is not attached to the document 61.”

If the wireless tag data is not stored, the CPU 11 executes document image reading processing (S4). In the document image reading processing (S4), the scanner unit 3 reads image data from the document 61. Then, after the image data of the document 61 is finished, the CPU 11 goes to step S10.

On the other hand, if the wireless tag data is stored (S5), the CPU 11 detects a data size (data volume) of the wireless tag data, and obtains the copying number data, the transfer setting data, the tag non-transmission setting data, and the receiving side copy setting data from the wireless tag data. The CPU 11 then stores the read data in the RAM 13, and particularly stores the detected data size in the transmitted wireless tag data size storage area 132.

the CPU 11 determines based on the copying number data and the number of designated communication devices (hereinafter referred to as the number of designated devices) whether the number of copying indicated by the copying number data is equal to or more than the number of designated devices.

If the number of copying the document 61 is equal to or more than the opposite-side number (S5: YES), the CPU 11 executes a document image reading processing (S6). That is, even if transmission of the image data based on the document 61 is carried out for the same number of as the number of designated devices, the number of designated devices is considered less than the number of copying. The scanner unit 3 reads the image data of the document 61. At this time, the CPU 11 associates the image data of the document 61 with the read wireless tag data to form the facsimile data 63, and stores the facsimile data in the transmitted facsimile data storage area 131.

After the document image reading processing (S6), the CPU 11 executes a wireless tag data updating processing (S7). In the wireless tag data updating processing (S7), the wireless tag writer 16 updates the copying number data stored in the wireless tag 62. More specifically, the CPU 11 subtracts the number of designated devices from the current number of copying so that the wireless tag writer 16 updates the number of copying the document 61. Then, the CPU 11 goes to step S10.

At this time, the CPU 11 updates the number of copying the document 61 based on detailed setting in the receiving side copy setting data. For example, in the case of “one time setting”, the CPU 11 updates the number of times for copying to a value obtained by subtracting a value that “1” is added to each of the number of designated devices (that is, “twice as large as the opposite-side number”) from the current number of times for copying. In addition, in the case of “0 time setting”, and in the case that the copying number data is “5” and two designated devices are designated for transmission, the copying number data is updated to “3”. Further, in the case of “complete reproducing setting”, the copying number data is updated to “0”.

Then, if the number of copying the document 61 is less than the number of designated devices (S5: NO), the CPU 11 displays on the LCD 18 to inform an error in the number of times and show that “the number of designated devices exceeds the number of copying” (S8), and ejects the document 61 from the document ejection opening (not shown). After ejecting the document 61 from the document ejection opening, the CPU 11 goes to step S10.

In this manner, the facsimile device 1 can prevent unintentional copying of information (here, the image data based on the document 61), and carry out suitable information management. In addition, the LCD 18 informs the error in the number of times. In this manner, the user can understand that the error in the number of times has occurred, and appropriately treat the facsimile transmission. For example, the adjustment can be made in a manner that the number of designated devices for transmitting the document 61 is reduced with the limited number of times for copying.

When the process goes to step S10, the CPU 11 determines whether all pages of the document 61 placed on the document placing table 2A have been read or not. If all pages have not been read yet (S10: NO), the process returns to step S2.

In the above manner, when the process of steps S2 to S10 are repeated for the document 61 by page, and all pages of the document 61 placed on the document placing table 2A are read (S10: YES), the CPU 11 combines the wireless tag data and the image data on a page basis to generate the facsimile data 63.

At this time, the CPU 11 sets the number of times for copying of the wireless tag data configuring the facsimile data 63 transmitted to the facsimile device 60 based on the receiving side copy setting data of the wireless tag 62 added to the document 61. That is, if “one time setting” is set in the opposite-side copy setting data of the document 61, the copying number data of the wireless tag data to be transmitted is set to be “the number of times for copying: 1 time”. In the case of “zero time setting”, the CPU 11 sets the copying number data of the wireless tag data to be transmitted to be “the number of times for copying: 0 time”. If “complete reproducing setting”, the CPU 11 sets the number of times for copying of the wireless tag data to be transmitted to be “the number of times for copying: the number of times obtained by subtracting the number of designated devices from the original copying number data.

By executing the above processing, the facsimile device 1 stores the facsimile data 63 of the document 61 generated on a page basis in the transmitted facsimile data storage area 131.

If any wireless tag data is not detected from any page of the document 61 (S3: NO), the facsimile data 63 which does not have the wireless tag data is created.

Thereafter, when the process goes to step S1, the CPU 11 starts calling to the designated device to start communication with the designated facsimile device 60.

Next, the CPU 11 stands by the processing until the CPU 11 receives an “NSF signal” from the facsimile device 60. Here, the “NSF signal” is a facsimile control signal transmitted from a receiving side device to a transmitting side device, and is a signal that notifies a non-standard function of the facsimile device 60 from the facsimile device 60 to the facsimile device 1.

When the CPU 11 receives the “NSF signal” (S12), the CPU 11 determines whether there exists the wireless tag data with respect to the document 61 or not (S13). More specifically, the CPU 11 makes the determination at step S13, referring to the transmitted wireless tag data size storage area 132. If the wireless tag data with respect to the document 61 is stored (S13: YES), the CPU 11 goes to step S16. On the other hand, if the wireless tag data with respect to the document 61 is not stored (S13: NO), the CPU 11 goes to step S14.

When the process goes to step S14, the CPU 11 transmits the facsimile data 63 corresponding to the document 61 to the facsimile device 60. In this case, the facsimile data 63 is configured only with the image data since the wireless tag data related to the document 61 is not included. In step S14, normal transmission of facsimile data is performed. When one page of the facsimile data 63 is transmitted, the CPU 11 goes to step S15.

In step S15, the CPU 11 determines whether all pages of the document 61 have been transmitted to the facsimile device 60 or not. If all pages of the document 61 are transmitted to the facsimile device 60 (S15: YES), the CPU 11 terminates the fax transmission processing program. On the other hand, if all pages of the document 61 have not been transmitted to the facsimile device 60 yet (S15: NO), the CPU 11 returns to step S14, and carries out facsimile transmission of the next page of the document 61.

Then, when the wireless tag data exists in the document 61 (S13: YES), the process goes to step S16, where the CPU 11 determines based on the “NSF signal” received in step S12 whether the facsimile device 60 has the “wireless tag data receiving function” or not. If the facsimile device 60 has the “wireless tag data receiving function” (S16: YES), the CPU 11 turns on the wireless tag data transmittable flag 133, and the process goes to step S17. On the other hand, if the facsimile device 60 does not have the “wireless tag data receiving function” (S16: NO), the CPU 11 turns off the wireless tag data transmittable flag 133, and process goes to step S21.

If the facsimile device 60 has the “wireless tag data receiving function”, the process goes to the step S17, and the CPU 11 transmits an “NSS signal” to the facsimile device 60. The “NSS signal” is a facsimile control signal transmitted from a transmitting side device to a receiving side device, and is a signal for notifying a setting relating to a non-standard function included in the transmitting side device to the receiving side facsimile device.

Here, in the facsimile device 1 of the present embodiment, the “NSS signal” includes size information indicating the size of the wireless tag data 64 included in the facsimile data 63. Therefore, by notifying the “NSS signal” to the facsimile device 60, the facsimile device 1 can notify the facsimile device 60 that the facsimile data 63 to be transmitted has the wireless tag data. The facsimile device 1 can notify the facsimile device 60 of the size information of the wireless tag data related to the facsimile data 63. Based on such notification, the facsimile device 60 can distinguish the wireless tag data and the image data.

After transmitting the “NSS signal” to the facsimile device 60, the CPU 11 reads one page of the facsimile data 63 from the transmitted facsimile data storage area 131, and transmits the one page of the facsimile data 63 to the facsimile device 60 (S18). The facsimile data 63 transmitted in step S18 is configured with the wireless tag data and image data.

Size information of the wireless tag data can be notified on a page basis.

After transmitting the facsimile data 63 to the facsimile device 60, the CPU 11 goes to step S19. In step S19, the CPU 11 erases one page of facsimile data 63 transmitted in step S18 from RAM 13. In this manner, the transmitted facsimile data 63 does not remain in the RAM 13. Therefore, the facsimile device 1 can ensure to prevent the facsimile data 63 from being left in the RAM 13 and being output from the RAM 13 due to an unintentional operation. That is, information management with respect to the document 61 can ensure to be carried out.

After erasing the facsimile data 63 which has already been transmitted by facsimile, the CPU 11 determines whether facsimile transmission of all pages of document 61 has completed or not (S20). If facsimile data of all pages has been transmitted (S20: YES), the CPU 11 terminates the facsimile transmission processing program. On the other hand, if the facsimile transmission for all pages has not completed yet (S20: NO), the CPU 11 returns to step S18, and executes facsimile transmission of a next page.

Next, the description will be made for the case where the facsimile device 60 does not have the “wireless tag data receiving function” (S16: NO). In this case, the CPU 11 displays on the LCD 18 that “the facsimile device 60 does not have the wireless tag data receiving function”, and displays to inquire the user about “whether the document 61 is to be transmitted to the facsimile device 60 or not”. The user operates the operation panel 17 to select execution of transmission or suspension of transmission to the facsimile device 60 in response to the inquiry.

In step S21, the CPU 11 determines whether transmission of data with respect to the document 61 is carried out or not, when the facsimile device 60 does not have the wireless tag data receiving function. That is, the CPU 11 carries out determination related to the selection displayed on the LCD 18 in step S21 in accordance with an instruction input by the user through the operation panel 17. If the transmission of the document 61 is selected (S21: YES), the CPU 11 goes to step S22. If “transmission prohibition setting” is set as the tag non-transmission setting data, in step S21 the CPU 11 determines that the suspension of transmission is selected.

On the other hand, if the suspension of transmission of the document 61 is selected (S21: NO), the CPU 11 goes to step S27. When the process goes to step S27, the CPU 11 stores the facsimile data 63 with respect to the document 61 in the transmitted data storing memory 141. After storing the facsimile data of the document 61 in the transmitted data storing memory 141, the CPU 11 goes to step S26. The LCD 18 may display that the facsimile data 63 is stored in the above manner.

When the process goes to step S22, the CPU 11 refers to the wireless tag data included in the document 61, and determines whether to execute the image processing or not. That is, the CPU 11 refers to the tag non-transmission setting data of the wireless tag data, and carries out determination in step S22 based on whether “processing transmission setting” is set or not. If “processing transmission setting” is set (S22: YES), the CPU 11 goes to step S23. On the other hand, if the “processing transmission setting” is not set (S22: NO), the CPU 11 goes to step S24.

When the process goes to step S23, the CPU 11 executes the image processing. The image processing (S23) is a processing for processing the image data scanned from the document 61 in a predetermined manner. More specifically, the CPU 11 carries out a processing for reducing image quality of the image data as the image processing. The image data with reduced image quality (hereinafter referred to as the processed image data) is generated based on the image data scanned by the scanner unit 3. The facsimile data 63 is made from the processed image data.

The method of the image processing executed in the image processing (S23) is not limited to the processing of reducing image quality. For example, the image processing may be a processing that converts the image data of a color image read by the scanner unit 3 to a monochrome image. Alternatively, the image processing may be such that an identification mark is added to a part of the image data. For example, when the image quality is lowered, and even if the print based on the facsimile data 63 can be visually confirmed in the facsimile device 60, the image quality of the printed image at the facsimile device 60 is further deteriorated. In this manner, further unintentional copy of the facsimile data 63 in the facsimile device 60 is restricted.

When the process goes to step S24, the CPU 11 transmits the facsimile data 63 to the facsimile device 60. The facsimile data 63 in S24 is configured only with the image data. Then, if the process passes through the image processing (S23), the facsimile data 63 is configured with the processed image data. If the processing does not pass through the image processing (S22: NO), the facsimile data 63 is configured with the image data read by the scanner unit 3.

In the subsequent step S25, the CPU 11 erases the transmitted facsimile data 63 from the RAM 13. In this manner, the transmitted facsimile data 63 does not remain in the RAM 13. Accordingly, the facsimile device 1 can ensure to carry out information management of the facsimile data 63. After the transmitted facsimile data 63 is erased, the CPU 11 goes to step S26.

After the facsimile data 63 which has already been transmitted by facsimile is erased, the CPU 11 determines whether the facsimile transmission of all pages of the document 61 has been completed or not (S26). If facsimile data of all pages has been transmitted (S26: YES), the CPU 11 terminates the facsimile transmission processing program. On the other hand, if the facsimile transmission of all pages has not been completed yet (S26: NO), the CPU 11 returns to step S18, and executes the facsimile transmission for the next page.

Next, the fax reception processing program of the facsimile device 1 will be described in detail with reference to FIG. 8.

As shown in FIG. 8, the fax receiving processing is executed, when a call has come to the facsimile device 1 and communication with the transmitting facsimile device (not shown) is started (S51).

When the process goes to step S52, the CPU 11 transmits the “NSF signal” to the transmitting facsimile device. As described above, the “NSF signal” is a signal that indicates that the transmitting facsimile device has the non-standard function (the “wireless tag data receiving function”). After transmitting the “NSF signal” to the transmitting facsimile device and notifying information as to the non-standard function such as the “wireless tag data receiving function”, the CPU 11 goes to step S53.

Thereafter, the CPU 11 stand by the next step until the CPU 11 receives the “NSS signal” from the transmitting facsimile device. When the CPU 11 receives the “NSS signal” from the transmitting facsimile device, the CPU 11 obtains size information of the wireless tag data included in the “NSS signal”, and stores the size information in the size information storage area 135 (see FIG. 2) (S53).

When the process goes to step S54, the CPU 11 determines based on size information included in the “NSS signal” whether the wireless tag data is included in the received data or not. If the wireless tag data is included in the received data (S54: YES), the CPU 11 goes to step S55. On the other hand, if the wireless tag data is not included in the received data (S54: NO), the CPU 11 goes to step S56.

In S55, the CPU 11 extracts the wireless tag data from the received data while receiving received data, and stores the wireless tag data in the RAM 13.

As described above, the facsimile data 63 which is received data is transmitted in the order of the wireless tag data and the image data. Therefore, the facsimile device 1 receives the facsimile data 63 in the order of the wireless tag data and the image data.

Since the facsimile device 1 already receives the “NSS signal” at the time of S53, the facsimile device 1 has obtained the data size of the wireless tag data of the facsimile data 63 by the size information included in the “NSS signal”. Therefore, the data having the same data size of the size indicated by the size information from a beginning of the received data corresponds to the wireless tag data.

That is, in S55, while receiving the received data, the CPU 11 indicates the data which has already received as the “wireless tag data” when the CPU 11 receives data for a size indicated by the size information. Then, the CPU 11 stores the identified wireless tag data in the received facsimile data storage area 134 in the RAM 13 after adding information with which page the wireless tag data is added. After receiving and storing the wireless tag data, the CPU 11 goes to step S56.

In subsequent S56, the CPU 11 receives the image data included the received data. When the CPU 11 receives the image data, the CPU 11 stores the image data in the received facsimile data storage area 134, and goes to step S57.

If the wireless tag data is not included in the received data (S54: NO), all the received data is the image data. In this case, identification of the wireless tag data is not carried out, and all the received data is stored as the image data in the received facsimile data storage area 134.

In the present embodiment, the wireless tag data and the image data are separated based on the size information of the wireless tag data while the received data is received. However, the present invention is not limited to the above manner. That is, the wireless tag data and the image data can be separated in accordance with the size information of the wireless tag data after all the received data is received.

After the process goes to step S57, the CPU 11 determines whether reception of the received data of all pages has completed or not. If the received data of all pages has been received (S57: YES), the CPU 11 goes to step S58. On the other hand, if the received data of all pages has not been completed yet (S57: NO), the CPU 11 returns to step S54, and continues reception of the next page of the data.

In the subsequent S58, the CPU 11 refers to a setting of the facsimile device 1, and whether the “transfer mode” is effective or not. Here, the “transfer mode” is a mode where facsimile data received by the facsimile device 1 is transmitted to a designated device. Whether the “transfer mode” is effective or ineffective is set in advance by the user of the facsimile device 1. If the “transfer mode” is effective (S58: YES), the CPU 11 goes to step S59. On the other hand, if the “transfer mode” is not effective (S58: NO), the CPU 11 goes to step S63.

When the process goes to step S59, the CPU 11 refers to the wireless tag data related to the received data. Then, the CPU 11 determines in the transfer setting data included in the wireless tag data whether transfer of the received data is permitted or not. If the transfer setting data indicates “transfer permitted” (S59: YES), the CPU 11 transfers the received data to the designation device designated in the “transfer mode” (S60). After transferring the received data to the designated device, the CPU 11 erases the transferred received data (S62), and terminates the fax reception processing program.

In the determining processing of S59, the CPU 11 treats the case in which the transfer setting data is not included in the received data (that is, the case that the transfer setting data is not included in the wireless tag data or the case that the wireless tag data is not included in the received data) as the case that “the transfer of data is permitted.”

On the other hand, if the transfer setting data indicates “transfer prohibited” (S59: NO), the CPU 11 stores the received data (the wireless tag data and the image data) in the flash memory 14 (S61). After storing the received data in the flash memory 14 without transferring the same, the CPU 11 terminates the fax reception processing program.

Here, the description will be made with respect to the case where the “transfer mode” is not effective in the facsimile device 1 (S58: NO). When the process goes to step S63, the CPU 11 determines whether the wireless tag data included in the received data is recordable or not. More specifically, the detection sensor 54 detects existence or nonexistence of the wireless tag 72 and the recordable capacity of the wireless tag 72 in the recording sheet in one of the first paper-feeding tray 51 to the third paper-feeding tray 53, and the CPU 11 determines based on the result by the detection sensor 54.

If the wireless tag data is recordable (S63: YES), the CPU 11 goes to step S64. On the other hand, if the wireless tag data is not recordable (S63: NO), the CPU 11 reads the received data (one page of the wireless tag data and the image data) from the RAM 13, and stores the received data in the flash memory 14 (S68). After storing the received data, the CPU 11 goes to step S67.

On the other hand, when the process goes to step S64, the CPU 11 reads the wireless tag data from the RAM 13, and writes the wireless tag data in the wireless tag 72 by the wireless tag writer 16 while conveying the recording paper 71 from one of the first paper-feeding tray 51 to the third paper-feeding tray 53. In this manner, the wireless tag 72 stores a content (that is, the copying number data) of the wireless tag data included in the received data.

After writing the wireless tag data in the wireless tag 72, the CPU 11 goes to step S65.

In S65, the CPU 11 executes the received image data recording processing based on the wireless tag data previously written. The received image data recording processing (S65) is a processing in which the laser printer 30 forms the image based on the image data on the recording paper 71 in which the wireless tag data is already written. Forming of the image based on the image data by the laser printer 30 is already well known. Therefore, the description thereof is omitted.

When the received image data recording processing (S65) is terminated, the CPU 11 goes to step S66. In the above description, the wireless tag data is first written in the wireless tag 72 due to positional relationship between the wireless tag writer 16 and the laser printer 30. This writing order can be changed.

Thereafter, the CPU 11 erases the wireless tag data which has been written in the wireless tag 72 and the image data which has been recorded on the recording paper 71 from the received facsimile data storage area 134 of the RAM 13 (S66). After erasing the wireless tag data and the image data of one page, the CPU 11 goes to step S67.

When the process goes to step S67, the CPU 11 determines whether processing with respect to all pages configuring the received data has been completed or not. If the processing for all pages has been completed (S67: YES), the CPU 11 terminates the fax reception processing program. On the other hand, if the processing for all pages has not been completed yet (S67: NO), the CPU 11 returns to step S63, and executes the processing for the next page.

As described above, in the facsimile device 1, when the document 61 is transmitted, whether the transmission of the document 61 is permitted or not is determined based on the copying number data written in the wireless tag 62. That is, the transmission of the document 61 is carried out only when the number of times for copying indicated by the copying number data is equal to or more than the number of designated facsimile devices (S5: YES). Accordingly, the facsimile device 1 can ensure to control and manage unintentional copying of information related to the document 61.

In addition, the facsimile device 1 displays the error on the LCD 18 when the number of designated facsimile devices exceeds the number of times for the copying the document 61. In this manner, the user can understand that the number of times for copying the document 61 is less than the number of designated devices. Accordingly, the user can appropriately change the designated device to receive the document 61.

Further, the facsimile device 1 updates the copying number data stored in the wireless tag 62 in accordance with the transmission mode of the document 61 (that is, the number of designated devices and the receiving-side copy setting data) at the time of transmission of the document 61. In this manner, information that may unintentionally leak from the document 61 may be appropriately controlled and managed.

If the “complete copying setting” is set in the receiving-side copy setting data, the copying number data for the document 61 is updated to “the number of times for copying: 0 time” (S7). In this manner, since the number of times for copying is smaller than the number of designated devices, the document 61 cannot be transmitted from the facsimile device 1. That is, the facsimile device 1 can prevent unintentional leak or copy of image data from the document 61, and strictly manage information.

Then, the facsimile device 1 transmits the copying number data to the facsimile device 60 when the designated facsimile device 60 has the “wireless tag data receiving function”. In this manner, the copying number data is written in the wireless tag 72 in the recording paper 71 when the facsimile device 60 receives the data.

That is, according to the facsimile device 1, unintentional leak or copy of image data can be controlled and managed based on the number of times for copying even on the receiving-side facsimile device 60. Accordingly, management of information desired by the user can be carried out on the receiving-side facsimile device.

In addition, the facsimile device 1 transmits the wireless tag data including the copying number data of “the number of times for copying: 0 time” to the facsimile device 60, when the wireless tag data of the document 61 is set as “0 time setting”. Accordingly, the wireless tag data of “the number of times for copying: 0 time” is written in the wireless tag 72 of the recording paper 71 to be recorded in the facsimile device 60. As a result, the recording paper 71 recorded in the facsimile device 60 has information that the recording paper 71 cannot be copied or transmitted by facsimile any more, since information read by the wireless tag reader 15 is “the number of times for copying: 0 time”. Accordingly, the facsimile device 1 can prevent unintentional copy or transmission of information therefrom. The management of information as desired by the user on a transmitting side can be carried out at the receiving-side device.

Then, if the facsimile device 60 does not have the “wireless tag data receiving function” (S16: NO), the facsimile device 1 prohibits the transmission of the facsimile data 63 based on the instruction through the operation panel 17 and the tag non-transmission setting data, and can store the read data in the transmitted data storing memory 141 (S27) and transmits only the image data of the facsimile data 63 (S24). In this manner, the facsimile device 1 can appropriately determine whether transmission of the data to the designated device is possible or not when the designated device does not have the “wireless tag transmission data receiving function.” And the management of information related to the image data to be transmitted becomes possible.

Further, if the facsimile device 60 does not have the “wireless tag data receiving function” (S16: NO), the facsimile device 1 executes the image processing (S23) on condition that “processing transmission setting” is set in the tag non-transmission setting data of the document 61. In this manner, the image data included in the facsimile data 63 becomes data obtained by processing the image data read by the scanner unit 3. As a result, the facsimile device 1 transmits the processed image data to the designated device which is difficult to control and manage an unintentional copy of the received data. Accordingly, even if the designated device does not have the function of receiving the wireless tag transmission data, management relating to the image data on the document 61 can be carried out.

In addition, if the “transfer setting data” is included in the wireless tag data, the facsimile device 1 transmits the wireless tag data including the “transfer setting data” to the facsimile device 60. That is, the user on the transmitting-side device can decide whether the transfer of the image data on the recording paper 71 recorded on the facsimile device 60 side is permitted or prohibited. As a result, the facsimile device 1 can prevent the image on the recording paper 71 recorded in the facsimile device 60 from being transferred against the an intention of the user of the facsimile device 1. Accordingly, management of information relating to the image data of the document 61 can be properly carried out.

In addition, according to the facsimile device 1, updating of the copying number data with respect to the document 61 and setting of the wireless tag data transmitted to the facsimile device 60 are executed by page. That is, the facsimile device 1 can manage information relating to leak of the image data on the basis of the copying number data of the document 61 on a page basis. Accordingly, management of information with respect to the document 61 can be strictly carried out.

Then, when the detection sensor 54 detects that the wireless tag 72 is added to the recording paper 71 (S63: YES), the facsimile device 1 records the image data on the recording paper 71 by the laser printer 30 based on the received data from the transmitting-side facsimile device, and writes the wireless tag data in the wireless tag 72. Then, if the detection sensor 54 does not detect the wireless tag 72 (S63: NO), the facsimile device 1 stores the received data in the flash memory 14 (S68). In this manner, the facsimile device 1 can prevent a situation where only the image data is recorded on the recording paper 71, and prevent unintentional copy or transmission of the received data against the intention of the user of the transmitting-side device.

In addition, if the received data from the transmitting-side facsimile device includes the wireless tag data, and the wireless tag data includes the copying number data, the facsimile device 1 writes the copying number data in the wireless tag 72 (S64). In this manner, if the facsimile device 1 is on a receiving side, the facsimile device 1 can control and manage with respect to unintentional leak of information (received data) in accordance with the intention of the user on the transmitting-side device that restricts copying of the recording paper 71.

Then, if the “transfer mode” is effective and the transfer setting data included in the received data indicates “transfer permitted”, the facsimile device 1 transfers the received data to the designated device by the “transfer mode”, and erases the transferred data (S60 and S62). In this manner, the facsimile device 1 executes the transfer of the received data in accordance with an intention of the user of the transmitting side device. Accordingly, the leak of the received data against the intention of the transmitting side device can be prevented. In addition, since the received data is transferred without any processing, the received data can ensure to be transmitted to the designated device which the user of the transmitting side device desires to transmit the image data.

Then, if the “transfer mode” is effective and the transfer setting data included in the received data indicates “transfer prohibited”, the facsimile device 1 does not carry out the transfer of the data to the designated device by the “transfer mode”, and stores the received data in the flash memory 14 (S61) instead of the transmission. Since the received data is not transferred by the facsimile device 1, the leak of the received data can be controlled and managed along an intention of a transmitting side. In addition, since the received data is stored in the flash memory 14, the designated device by the user on a transmitting side can check the received data later.

It is understood that the foregoing description and accompanying drawings set forth the embodiments of the invention at the present time. Various modifications, additions and alternative designs will, of course, become apparent to those skilled in the art in light of the foregoing teachings without departing from the spirit and scope of the disclosed invention. Thus, it should be appreciated that the invention is not limited to the disclosed embodiments but may be practiced within the full scope of the appended claims.

For example, the wireless tag reader 15, the wireless tag writer 16, the scanner device 22, and the laser printer 30 may be external devices which are connected to the facsimile device 1 with a cable.

The present invention can be applied to a facsimile device that reads the image data in a flatbed system.

Further, the present embodiment has been described by the case in which the recording paper and the wireless tag are formed in an integrated manner. However, the present invention is not limited thereto. For example, the recording paper and the wireless tag may be separated depending on a configuration of the receiving side device. In this case, when the image data and the wireless tag data corresponding thereto are received in the facsimile receiving processing, the image data is recorded on a normal recording sheet and the wireless tag data is written in the separate wireless tag.

The separate wireless tag as described above includes a adhesive part on a back surface like a label, and may be attached to recording paper on which the corresponding image data is recorded automatically or manually after the wireless tag data is written. In this manner, by adding the wireless tag to recording sheet, the recording sheet having the wireless tag data can be obtained. Similarly, the document and the wireless tag do not need to be integrated on a transmitting side device, and may be read separately as long as each page of the document is managed to be associated with the wireless tag.

What is claimed is:

1. A communication device, comprising:
a reading unit that reads image data from an original document, the original document a first wireless tag including first wireless tag data, the first wireless tag data including first copying number data having first number of time for allowing copying the original document, the first number being more than or equal to zero;
a wireless tag reading unit that reads the first wireless tag data from the wireless tag;
a transmitting unit that transmits the image data;
a designating unit that designates second number of second communication device to which the image data is transmitted, the second number being more than zero;
a first determining unit that determines whether the first number is more than the second number; and
a control unit that determines based on a determination by the first determining unit whether the transmitting unit is allowed to transmit the image data or not.

2. The communication device according to claim 1, further comprising:
an informing unit that informs that the first number is less than the second number, if the first determining unit determines that the first number is less than the second number.

3. The communication device according to claim 1, further comprising:
an updating unit that subtracts the second number from the first number to update the first number.

4. The communication device according to claim 1, further comprising:
an updating unit that updates the first copying number data to copying prohibition data which prohibits copying the original document after the image data is transmitted.

5. The communication device according to claim 3, further comprising:
a generating unit that generates wireless tag transmission data based on the wireless tag data, the wireless tag transmission data being to be transmitted by the transmitting unit, the wireless tag transmission data being to be written by the second communication device to a second wireless tag; and
a second determining unit that determines whether the second communication device has a function for receiving the wireless tag transmission data.

6. The communication device according to claim 5, wherein the transmitting unit transmits the image data and the wireless tag transmission data if the second determining unit determines that the second communication device has the function for receiving the wireless tag transmission data,
the wireless tag transmission data has third number of times for allowing copying the original document, the third number being generated by subtracting the second number from the first number.

7. The communication device according to claim 5, wherein the transmitting unit transmits the image data and the wireless tag transmission data if the second determining unit determines that the second communication device has the function for receiving the wireless tag transmission data,
the wireless tag transmission data includes a copying prohibition command to prohibit the second communication device from copying the original document.

8. The communication device according to claim 5, further comprising:
a selecting unit that selects either one of a first mode and a second mode, the first mode being for prohibiting the transmitting unit from transmitting the image data, the second mode being for transmitting the image data without transmitting the wireless tag transmission data, if the second determining unit determines that the second communication device does not have the function for receiving the wireless tag transmission data, wherein
the control unit determines based on the selected one of the first and second modes whether the image data should be transmitted to the second communication device.

9. The communication device according to claim 5, further comprising:
an image processing unit that processes the image data if the second determining unit determines that the second communication device does not have the function for receiving the wireless tag transmission data, wherein
the transmitting unit transmits the processed image data to the second communication device.

10. The communication device according to claim 5, wherein the control unit attaches transfer setting data to the wireless tag transmission data, the transfer setting data being included in the first wireless tag data and indicating whether transfer of the image data by the second communication device is allowed or not.

11. The communication device according to claim 5, wherein the reading unit read the image data from the original document on a page basis, the original document including a plurality of pages, each of the plurality of pages having the first wireless tag,
the updating unit updates the first number on the page basis, and
the generating unit generates the wireless tag transmission data on the page basis.

12. A communication device, comprising:
a receiving unit that receives data including image data and wireless tag transmission data through lines;
a separating unit that separates the wireless tag transmission data from the image data;
a printing unit that prints the image data on a recording sheet;
a writing unit that writes the wireless tag transmission data to a wireless tag;
a storing unit that stores the received data;
a first determining unit that determines whether the recording sheet has the wireless tag or not;
a control unit that controls the printing unit, the writing unit, and the storing unit, wherein
the printing unit prints the image data on the recording sheet and the writing unit writes the wireless tag transmission data in the wireless tag, if the first determining unit determines that the recording paper has the wireless tag, and
the storing unit stores the received data, if the first determining unit determines that the recording paper does not have the wireless tag.

13. The communication device according to claim 12, further comprising:
a second determining unit that determines whether the wireless tag transmission data includes copying number data indicating number of times for allowing copying based on the received data, wherein
the writing unit writes the copying number data in the wireless tag, if the second determining unit determines that the wireless tag transmission data includes the copying number data.

14. The communication device according to claim 12, further comprising:
a transfer unit that transfers the received data, the wireless tag transmission data including transfer setting data indicating whether transfer of the image data is allowed or not;
a third determining unit that determines whether the transfer setting data indicates that transfer of the image data is allowed or not; and
a forth determining unit that determines whether the transfer unit is active or not, wherein
the control unit controls the transfer unit, and
the transfer unit transfers the received data to a predetermined communication device and the control unit erases the received data which has been stored in the storing unit, if the transfer unit is active and the transfer setting data indicates that transfer of the image data is allowed.

15. The communication device according to claim 14, wherein the storing unit stores the received data, if the transfer unit is active and the transfer setting data indicates that transfer of the image data is not allowed.
